(19) United States
(12) Patent Application Publication
(10) Pub. No.: US 2024/0200786 A1
(43) Pub. Date: Jun. 20, 2024

(54) COOKING APPLIANCE WITH VAPOR GENERATOR

(71) Applicant: WHIRLPOOL CORPORATION, BENTON HARBOR, MI (US)

(72) Inventors: Lorenzo Ballerio, Varese (IT); Ivana Helena Grochowicz, Santa Catarina (BR); Sergio Richardo Jager, Rio Claro (BR); Mohammed Sultan Nadeem, Benton Harbor, MI (US); Leonardo Poma, Saronno (IT); Agata Rusnarczyk, Benton Harbor, MI (US)

(73) Assignee: WHIRLPOOL CORPORATION, BENTON HARBOR, MI (US)

(21) Appl. No.: 18/130,961

(22) Filed: Apr. 5, 2023

Related U.S. Application Data
(60) Provisional application No. 63/432,783, filed on Dec. 15, 2022.

(51) Int. Cl. F24C 15/00; A47J 27/04

(52) U.S. Cl. CPC F24C 15/003; A47J 27/04; A47J 2027/043

(57) ABSTRACT

A cooking appliance includes a body, a cooking cavity defined by the body, a fluid tank, and a vapor generator. The fluid tank is removably coupled to the body. The fluid tank is movable between an installed position and an extended position relative to the body. The fluid tank includes a handle that is rotatable about an axis between a neutral position and a rotated position. The vapor generator receives fluid from the fluid tank. Vapor produced by the vapor generator is provided to the cooking cavity.

### CROSS-REFERENCE TO RELATED APPLICATIONS

This application claims priority to U.S. Application No. 63/432,782 filed on Dec. 15, 2022, entitled “COOKING APPLIANCE WITH VAPOR GENERATOR,” the disclosure to which is hereby incorporated herein by reference in its entirety.

### BACKGROUND OF THE DISCLOSURE

The present disclosure generally relates to a cooking appliance, and more specifically, to a cooking appliance with a vapor generator.

### SUMMARY OF THE DISCLOSURE

According to one aspect of the present disclosure, a cooking appliance comprises a body, a cooking cavity defined by the body, and a fluid tank removably coupled to the body, wherein the fluid tank is movable between an installed position and an extended position relative to the body, and wherein the fluid tank comprises a handle that is rotatable about an axis between a neutral position and rotated position. A vapor generator is in fluid communication with and that receives a fluid from the fluid tank, wherein vapor produced by the vapor generator is provided to the cooking cavity.

According to another aspect of the present disclosure, a cooking appliance comprises a body, a cooking cavity defined by the body, and a fluid tank removably coupled to the body, wherein the fluid tank is movable between an installed position and an extended position relative to the body, and wherein the fluid tank comprises a handle that is rotatable about an axis between a neutral position and a rotated position and a handle-supporting portion having an angled portion angled away from an interior surface of the handle such that the interior surface of the handle at a predetermined region of the handle is spaced from the angled portion when the handle is in the neutral position. A vapor generator is in fluid communication with and that receives a fluid from the fluid tank, wherein vapor produced by the vapor generator is provided to the cooking cavity.

According to yet another aspect of the present disclosure, a cooking appliance comprises a cooking appliance a cooking cavity defined by a body. A fluid tank is removably coupled to the body, wherein the fluid tank is movable between an installed position and an extended position relative to the body, and wherein the fluid tank comprises a handle that is rotatable about an axis rotatable between a neutral position and a rotated position. The fluid tank comprises an upper handle-adjacent surface and a lower handle-adjacent surface each sloped away from the handle such that an upper recess and a lower recess are provided. A vapor generator in fluid communication with and that receives a fluid from the fluid tank, wherein vapor produced by the vapor generator is provided to the cooking cavity.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front view of a cooking appliance, illustrating an access panel in an open position, according to one example;

FIG. 2 is a side perspective view of a user interface of the cooking appliance, illustrating a fluid tank in an extended position, according to one example;

FIG. 3 is a side perspective view of the fluid tank, illustrating various components thereof, according to one example;

FIG. 4 is a side view of a handle of the fluid tank, illustrating the handle in a neutral position, according to one example;

FIG. 5 is a side view of the handle of the fluid tank, illustrating the handle in a rotated position, according to one example;

FIG. 6 is a cross-sectional view of the fluid tank, taken along line VI-VI of FIG. 3, illustrating the handle and components that interact with the handle while the handle is in the neutral position, according to one example;

FIG. 7 is a cross-sectional view of the fluid tank, taken along line VI-VI of FIG. 3, illustrating the handle and components that interact with the handle while the handle is in the rotated position, according to one example;

FIG. 8 is a rear perspective view of the handle, illustrating various components thereof, according to one example;

FIG. 9 is a front perspective view of the fluid tank and a tank housing, illustrating the handle removed therefrom, according to one example;

FIG. 10 is top perspective view of a rearward region of the tank housing and the fluid tank, illustrating an interaction with a position sensor, according to one example;

FIG. 11 is a cross-sectional view of the rearward region of the tank housing and the fluid tank, taken along line VI-VI of FIG. 3, illustrating a fluid valve, according to one example;

FIG. 12 is a cross-sectional view of the tank housing and the fluid tank, taken along line XII-XII of FIG. 3, according to one example;

FIG. 13 is a cross-sectional view of the tank housing and the fluid tank, taken along line XIII-XIII of FIG. 3, according to one example;

FIG. 14 is top perspective view of the fluid tank, according to one example; and

FIG. 15 is bottom perspective view of the fill cover of the fluid tank, according to one example.

The components in the figures are not necessarily to scale, emphasis instead being placed upon illustrating the principles described herein.

### DETAILED DESCRIPTION

The present illustrated embodiments reside primarily in combinations of method steps and apparatus components related to a cooking appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

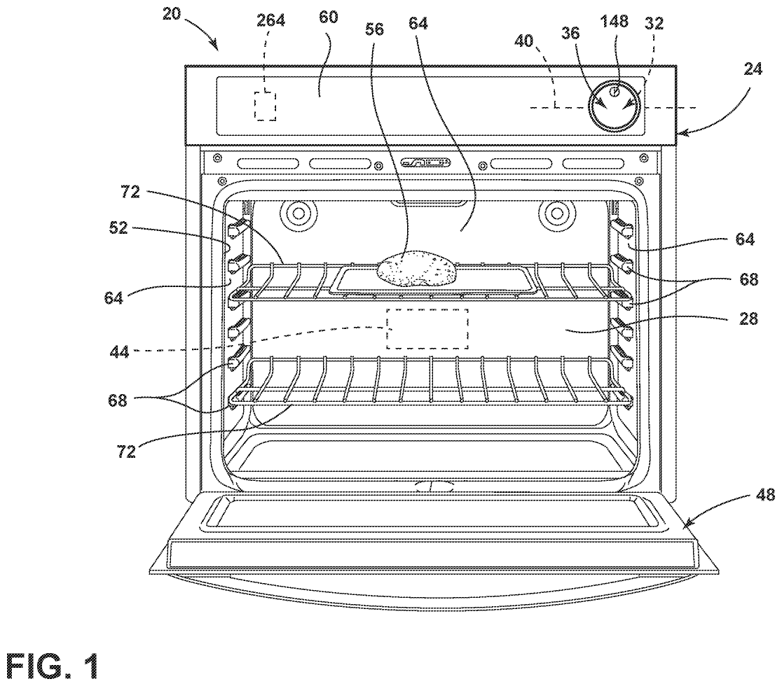

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

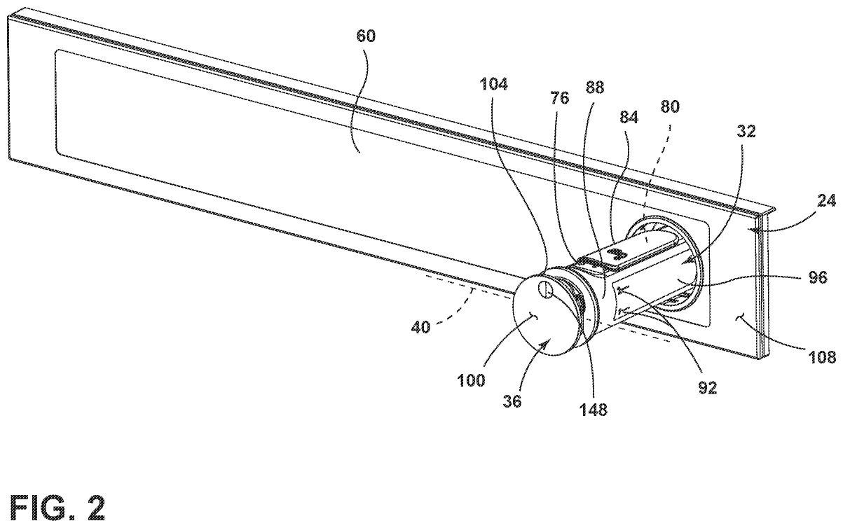

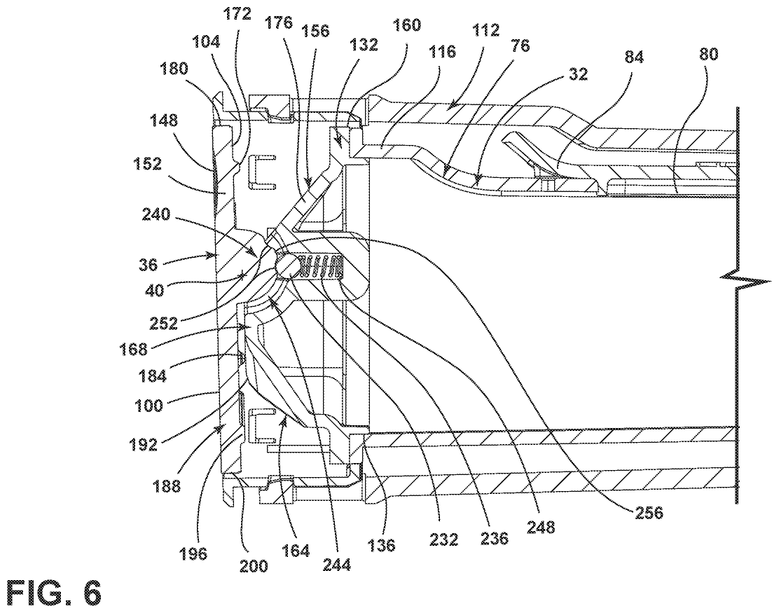

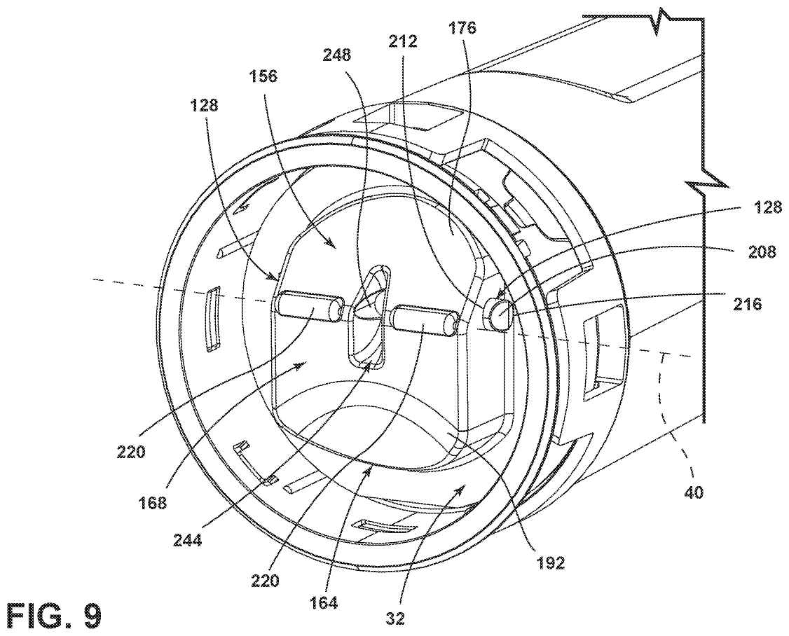

Referring to FIGS. 1-15, reference numeral 20 generally designates a cooking appliance. The cooking appliance 20 includes a body 24 and a cooking cavity 28 that is defined by the body 24. A fluid tank 32 is removably coupled to the body 24. The fluid tank 32 is movable between an installed position (e.g., see FIGS. 1 and 6) and an extended position (e.g., see FIG. 2) relative to the body 24. The fluid tank 32 includes a handle 36 that is at least partially rotatable about an axis 40. In various examples, the axis 40 about which the handle 36 is configured to rotate may be a horizontal axis. The cooking appliance 20 also includes a vapor generator 44 that receives fluid from the fluid tank 32. Vapor produced by the vapor generator 44 is provided to the cooking cavity 28. In one specific example, the fluid contained within the fluid tank 32 may be water such that interaction between the water and the vapor generator 44 may produce steam that can then be delivered to the cooking cavity 28. The vapor provided to the cooking cavity 28 as a result of interaction between the fluid from the fluid tank 32 and the vapor generator 44 may be employed in one or more cooking operations that the cooking appliance 20 is configured to perform.

Referring again to FIGS. 1 and 2, the cooking appliance 20 can be provided with an access panel 48, such as a door. The access panel 48 is rotatably coupled to the body 24 of the cooking appliance 20 such that the access panel 48 is movable between an open position (see FIG. 1) and a closed position relative to an access aperture 52 that is defined by the body 24. In one example of operating the cooking appliance 20, a user may rotate the access panel 48 from the closed position to the open position such that the access aperture 52 is revealed and access to the cooking cavity 28 is provided. After placing the access panel 48 in the open position, the user may insert a foodstuff 56 into the cooking cavity 28, where the foodstuff 56 is intended to be heated, cooked, or otherwise acted upon by the cooking appliance 20. Once the foodstuff 56 has been positioned within the cooking cavity 28, the user may place the access panel 48 in the closed position and interact with a user interface 60 of the cooking appliance 20. For example, interaction with the user interface 60 may include selecting a desired temperature within the cooking cavity 28 and/or selecting a desired cook time for the foodstuff 56. In some examples, interior walls 64 that define the cooking cavity 28 may be provided with one or more support structures 68. For example, opposing ones of the interior walls 64 (e.g., a left wall and a right wall as depicted in FIG. 1) may be provided with one or more of the support structures 68 arranged in a manner that allows a support rack 72 to rest thereupon and extend therebetween while maintaining the support rack 72 as substantially level. In various examples, the support rack 72 may be a wireframe rack that defines spaces between adjacent portions of the wireframe. Alternatively, the support rack 72 may provide a continuous surface upon which items, such as the foodstuff 56, may be placed.

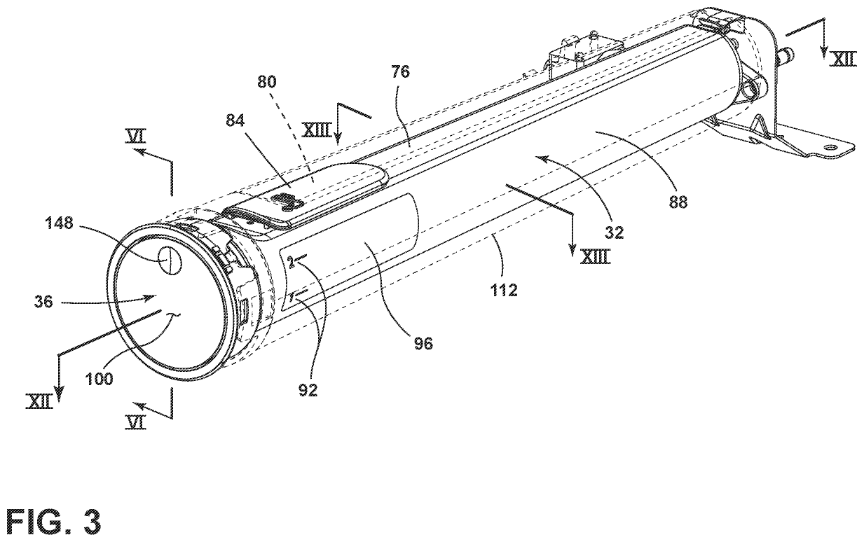

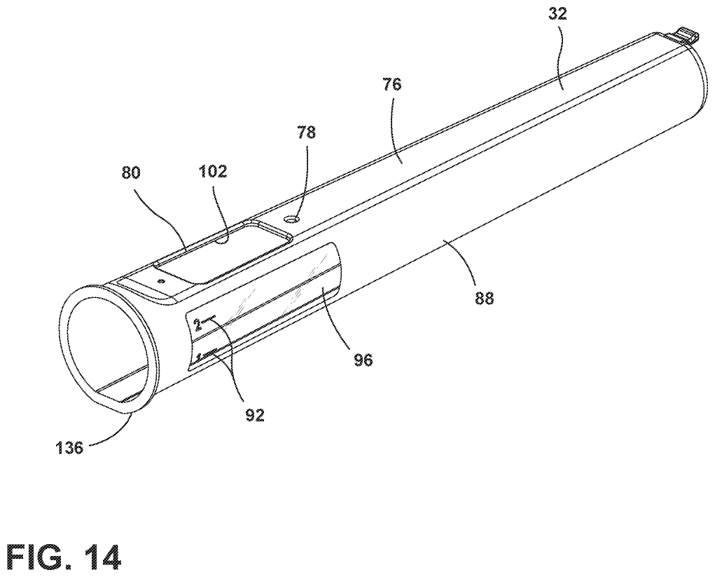

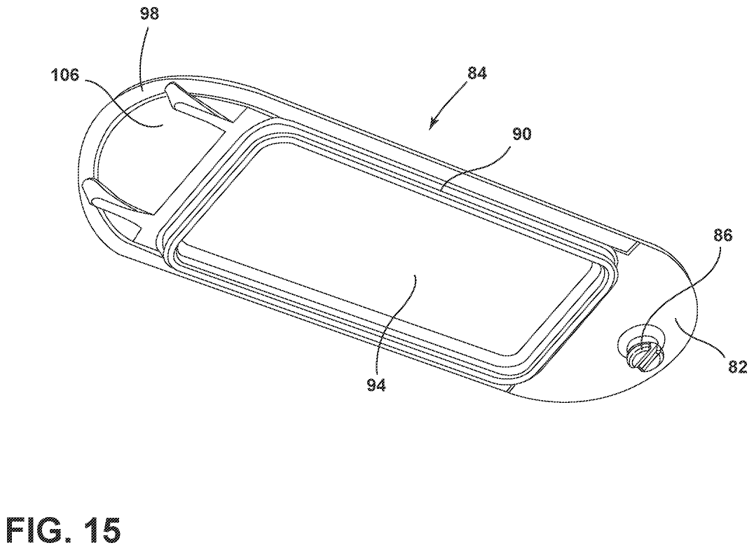

Referring now to FIGS. 2 and 3, an upper surface 76 of the fluid tank 32 may define a fill aperture 80 through which a user may add fluid to the fluid tank 32. The fill aperture 80 may receive a fill cover 84 that is configured to retain the fluid within the fluid tank 32. In various examples, the fill cover 84 may be constructed of a pliable material (e.g., silicone). In addition, as shown in FIG. 14, the upper surface 76 of the fluid tank 32 may include an opening 78 disposed proximate the fill aperture 80. As perhaps best shown in FIG. 15, the fill cover 84 may be provided with a snap tab 86 on a first end 82, wherein the snap tab 86 may be fittingly received within the opening 78 to secure the fill cover 84 to the upper surface of the 76 of the fluid tank 32 proximate the fill aperture 80. A rib 90 may be provided on an inner surface 94 of the fill cover 84 that resiliently engages an outer perimeter 102 of the fill aperture 80 to form a seal therewith when engaged. A grip 98 may be included on a second opposite end 106 of the fill cover 84 by which a user may manipulate the fill cover 84 into and out of engagement with the fill aperture 80 and by which therefor fluid, such as water, may be added to the fluid tank 32 for use by the vapor generator 44, as described above.

In some examples, a side surface 88 of the fluid tank 32 may be provided with one or more graduation marks 92. The graduation mark(s) 92 may provide the user with information relating to a current volume of fluid contained within the fluid tank 32. In some examples, a first graduation mark 92 may indicate a max fill line to the user relative to an internal volume of the fluid tank 32, while a second graduation mark 92 may indicate to the user a minimum volume of fluid within the fluid tank 32 necessary to provide the vapor to the cooking cavity 28 for a given mode of operation of the cooking appliance 20.

Referring again to FIGS. 2 and 3, in some examples, the fluid tank 32 may be made from a translucent material such that the volume within the fluid tank 32 may be ascertained by the user viewing, for example, the side surface 88 of the fluid tank 32. In various examples, a translucent or transparent window 96 may be defined in the side surface 88 of the fluid tank 32, with the translucent or transparent window 96 enabling the user to ascertain the current volume of fluid within the fluid tank 32. In such an example, the remainder of the fluid tank 32 may be less translucent than the translucent or transparent window 96. In some examples, the graduation marks 92 may be provided as co-localized within a surface area of the translucent window 96.

The handle 36 of the fluid tank 32 includes an exterior surface 100 and an interior surface 104. The exterior surface 100 of the handle 36 may be substantially coplanar with a front surface 108 of the body 24 when the fluid tank 32 is in the installed position. In various examples, the fluid tank 32 may be positioned proximate to the user interface 60. In such examples, the exterior surface 100 of the handle 36 may be substantially coplanar with a front surface of the user interface 60 when the fluid tank 32 is in the installed position.

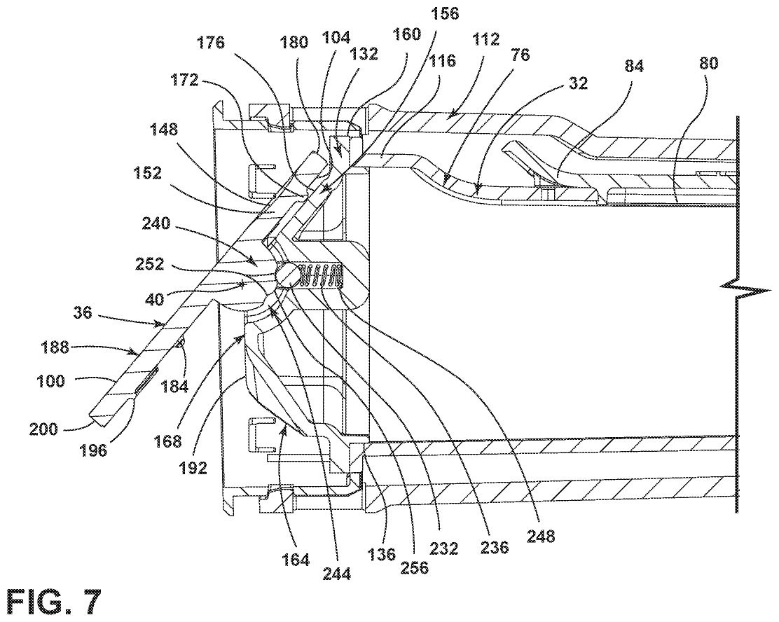

Referring to FIGS. 6-7, the body 24 of the cooking appliance 20 can be provided with a tank housing 112 that is configured to receive the fluid tank 32. The tank housing 112 may have a shape and/or contours that generally correspond with a shape and/or contours of the fluid tank 32. The portion of the upper surface 76 of the fluid tank 32 that is provided with the fill aperture 80 and the fill cover 84 may be recessed relative to a forward portion 116 of the upper surface 76. The handle 36 of the fluid tank 32 includes pivot brackets 120 that extend from the interior surface 104. Each pivot bracket 120 defines a slot 124 therein. In various examples, the slots 124 may be arcuate in shape. In one specific example, the slots 124 may be generally kidney-shaped or bean-shaped. Each of the slots 124 receive a tab 128 that extends from a handle-supporting portion 132 of the fluid tank 32. In various examples, the handle-supporting portion 132 of the fluid tank 32 may be received within a forward aperture 136 defined by a vessel portion 142 of the fluid tank 32.

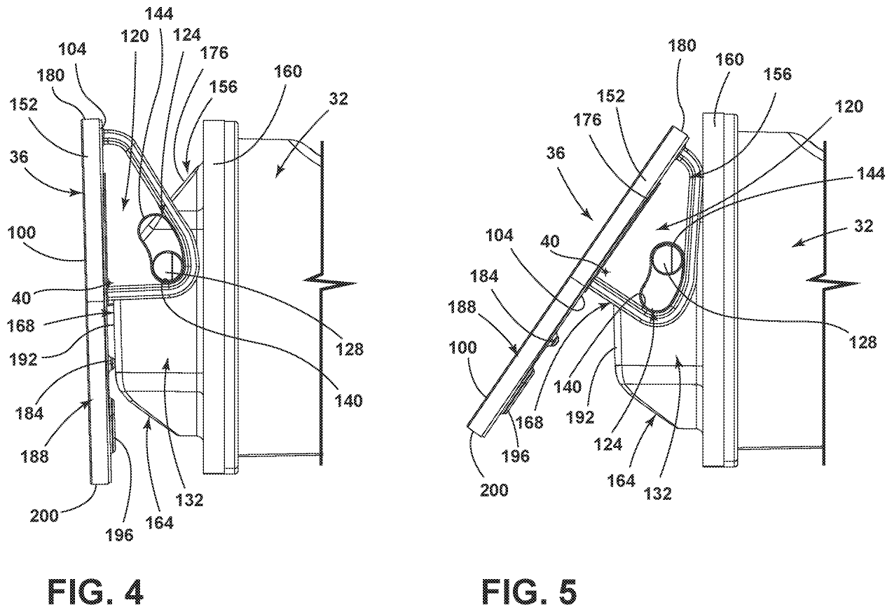

Referring to FIGS. 4-7, a lower extreme 140 of the slot 124 may correspond with a rest position or neutral position of the handle 36. The rest position or neutral position of the handle 36 may correspond with the handle 36 being flush or substantially coplanar with the front surface 108 of the body 24 when the fluid tank 32 is in the installed position. An upper extreme 144 of the slots 124 corresponds with a rotated position of the handle 36. The rotated position of the handle 36 arranges the handle 36 in a non-parallel orientation relative to the front surface 108 of the body 24. In some examples, the handle 36 may be biased toward the neutral position such that entering the rotated position of the handle 36 requires external input (e.g., user actuation). In various examples, the exterior surface 100 of the handle 36 may define a depression 148 in an upper region 152 of the handle 36. The depression 148 may be employed as a visual representation to the user that indicates a location where pressure may be applied to induce rotation of the handle 36 about the axis 40.

Referring further to FIGS. 4-7, an upper portion 156 of the handle-supporting portion 132 of the fluid tank 32 may be angled away from the handle 36 such that the interior surface 104 at the upper region 152 of the handle 36 is spaced from the upper portion 156 when the handle 36 is in the neutral position. The angled orientation of the upper portion 156 of the handle-supporting portion 132 may extend from an area proximate to the axis 40 to a perimeter wall 160 of the handle-supporting portion 132. The perimeter wall 160 of the handle-supporting portion 132 may directly abut the portion of the fluid tank 32 that defines the forward aperture 136. A lower portion 164 of the handle-supporting portion 132 may angle away from the interior surface 104 in a manner that is similar to the arrangement of the upper portion 156. However, the extent of the angled arrangement of the lower portion 164 may not extend to the region that is proximate to the axis 40. Additionally, or alternatively, the angled orientation of the lower portion 164 may not extend to the perimeter wall 160 of the handle-supporting portion 132. Accordingly, in some examples the upper portion 156 and the lower portion 164 of the handle-supporting portion 132 may be asymmetrical with one another along at least one cross-sectional plane of the fluid tank 32.

Referring still further to FIGS. 4-7, in various examples, the handle-supporting portion 132 may be provided with an intermediate portion 168 that is positioned between the upper portion 156 and the lower portion 164. The intermediate portion 168 may support the handle 36 when the handle 36 is in the neutral position. For example, the intermediate portion 168 of the handle-supporting portion 132 may prevent rotation of the handle 36 toward the lower portion 164 when the handle 36 is in the neutral position. In various examples, a space between the interior surface 104 and the lower portion 164 may provide a grasping region to the user.

Referring yet again to FIGS. 4-7, the interior surface 104 of the handle 36 may be provided with one or more upper protrusions 172 that is positioned in the upper region 152 of the handle 36. In various examples, the upper protrusion 172 can be sized and positioned to engage with a surface 176 of the upper portion 156 of the handle-supporting portion 132. The engagement between the upper protrusion 172 and the surface 176 of the upper portion 156 when the handle 36 is in the rotated position can prevent an upper edge 180 of the handle 36 from coming into contact with the perimeter wall 160. The interior surface 104 of the handle 36 may be provided with one or more lower protrusions 184 that are positioned in a lower region 188 of the handle 36. The one or more lower protrusions 184 can be sized and positioned to engage with a surface 192 of the intermediate portion 168 of the handle-supporting portion 132. The engagement between the one or more lower protrusions 184 and the surface 192 of the intermediate portion 168 can aid in maintaining the handle 36 in a position that orients the exterior surface 100 of the handle 36 as substantially flush or coplanar with the front surface 108 of the body 24 when the fluid tank 32 is in the installed position.

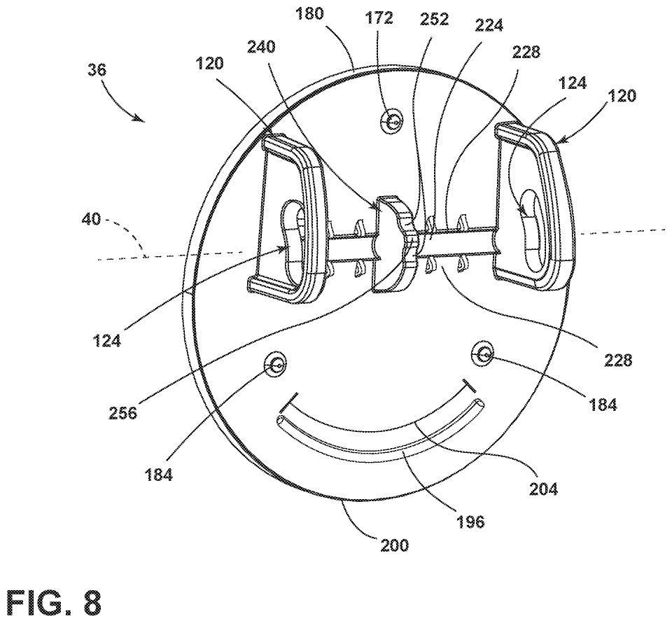

Referring again to FIGS. 4-7, in some examples, the handle 36 may be provided with a ridge 196 that extends from the interior surface 104. In such examples, the ridge 196 may be positioned closer to a lower edge 200 of the handle 36 than the one or more lower protrusions 184. Accordingly, the ridge 196 may be arranged to extend outwardly from the interior surface 104 to occupy a portion of the space that is defined between the interior surface 104 and the lower portion 164 of the handle-supporting portion 132. In various examples, the ridge 196 may be elongated and curvilinear, such that the ridge 196 extends in path corresponding to a perimeter of the handle 36. The elongation of the ridge 196 may be configured for engagement by a finger pad of the user as the user seeks to extract the fluid tank 32 from the body 24 of the cooking appliance 20. For example, an arc length 204 (see FIG. 8) of the ridge 196 may be at least about 1.0 cm, at least about 1.5 cm, at least about 2.0 cm, or another suitable length based on available surface area of the interior surface 104 of the handle 36.

Referring to FIGS. 6-9, a forward surface 208 of the tabs 128 may be sloped to aid in assembly of the handle 36 to the remainder of the fluid tank 32. Accordingly, a thickness of the tabs 128 at a forward edge 212 may be less than a thickness of the tabs 128 at a rearward edge 216. One or more elongated protuberances 220 may be positioned approximately at an inflection point between the upper portion 156 and the intermediate portion 168 of the handle-supporting portion 132. The one or more elongated protuberances 220 may be received within a valley 224 defined between support rib pairs 228 of the handle 36. The one or more elongated protuberances 220 may maintain physical contact with the valley 224 and/or the support rib pairs 228 throughout a full rotational range of motion of the handle 36. Such maintained contact between the elongated protuberances 220 may reduce or prevent a perceived looseness to the coupling between the handle 36 and the remainder of the fluid tank 32 by a user. The fluid tank 32 can include an engagement member 232 and a biasing member 236. The biasing member 236 biases the engagement member 232 to an extended position such that the engagement member 232 maintains physical contact with a portion of the handle 36.

Referring again to FIGS. 6-9, the interior surface 104 of the handle 36 includes a projection 240. The projection 240 extends rearwardly from the interior surface 104. The projection 240 is received within a cavity 244 that is defined by the handle-supporting portion 132. The cavity 244 can be positioned such that the cavity 244 is partially located in the upper portion 156 and partially located in the intermediate portion 168. In various examples, the cavity 244 may be positioned between the elongated protuberances 220. The cavity 244 includes a channel 248 that receives the biasing member 236 and the engagement member 232. The projection 240 of the handle 36 defines one or more notches 252. When two or more of the notches 252 are defined in the projection 240, adjacent ones of the notches 252 may be separated by a step 256. In the depicted example, the projection 240 is provided with two of the notches 252. One of the notches 252 is associated with the rest position or neutral position of the handle 36 (see FIG. 6) and may be referred to as a lower notch. The other of the notches 252 is associated with the rotated position of the handle 36 (see FIG. 7) and may be referred to as an upper notch.

Referring further to FIGS. 6-9, when the handle 36 is in the rest position or neutral position, the biasing member 236 provides a biasing force in an outward direction from the channel 248 such that the engagement member 232 is held in physical contact with the lower notch. Similarly, when the handle 36 is in the rotated position, the biasing member 236 provides a force in an outward direction from the channel 248 such that the engagement member 232 is in physical contact with the upper notch. As the handle 36 is transitioned between the neutral position and the rotated position, the engagement member 232 traverses the step 256. Such traversal of the step 256 results in a force being applied to the biasing member 236 that opposes the biasing force provided by the biasing member 236. For example, when the biasing member 236 is a compression spring, traversal of the step 256 by the engagement member 232 results in compression of the biasing member 236 in an inward direction toward the channel 248.

Referring still further to FIGS. 6-9, when a user applies an inward force on the depression 148 while the handle 36 is in the neutral position, the handle 36 is transitioned toward the rotated position and the engagement member 232 is transitioned from the lower notch to the upper notch. In some examples, the engagement between the engagement member 232 and the upper notch 252 while the handle 36 is in the rotated position may retain the handle 36 in the rotated position until a second external force is applied to the handle 36. For example, the second external force may be the user applying an inward force or pressure to the exterior surface 100 of the handle 36 within the lower region 188 of the handle 36. In various examples, the upper region 152 of the handle 36 may be defined as a region that is above the axis 40. Similarly, in some examples, the lower region 188 of the handle 36 may be defined as portions of the handle 36 that are positioned below the axis 40. In various examples, the handle 36 may be biased toward the neutral position such that the handle 36 does not remain in the rotated position without a constant external pressure being applied to the upper region 152 of the handle 36.

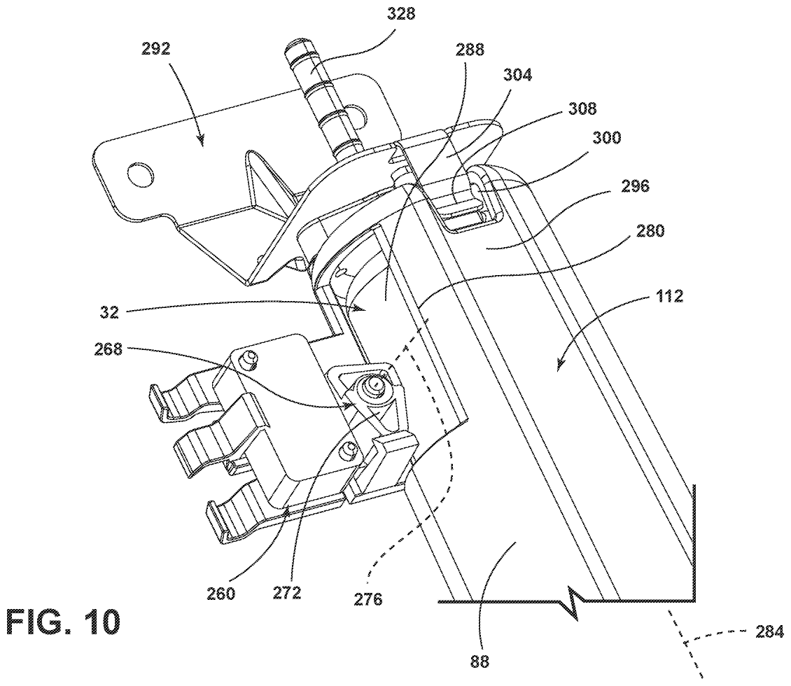

Referring to FIG. 10, the cooking appliance 20 is provided with a position switch 260 that informs a controller 264 (see FIG. 1) of the cooking appliance 20 regarding a current position of the fluid tank 32 within the tank housing 112. For example, the position switch 260 may inform the controller 264 whether the fluid tank 32 is fully-inserted into the tank housing 112 or whether the fluid tank 32 is sufficiently inserted into the tank housing 112 to establish fluid coupling with the vapor generator 44. The position switch 260 includes an actuation arm 268. The actuation arm 268 is movably coupled to an arm bracket 272 of the position switch 260. For example, the actuation arm 268 may be rotatably coupled to the arm bracket 272. In such an example, the actuation arm 268 may rotate about a rotation axis 276, where a rotational position of the actuation arm 268 indicates to the controller 264, by way of the position switch 260, whether the fluid tank 32 is fully-inserted within the tank housing 112 or if the fluid tank 32 is not fully-inserted into the tank housing 112. In the depicted example, the tank housing 112 is provided with a switch aperture 280 that is defined in one of the side surfaces 88 of the fluid tank 32. When the fluid tank 32 is not fully-inserted into the tank housing 112, the actuation arm 268 may rotate toward a centerline 284 of the tank housing 112. Such a positioning of the actuation arm 268 may result in the position switch 260 assuming an open arrangement (e.g., preventing current flow). When the fluid tank 32 is fully-inserted within the tank housing 112, an exterior surface 288 of the fluid tank 32 may physically contact the actuation arm 268 and induce rotational motion of the actuation arm 268 away from the centerline 284 about the rotation axis 276. Such positioning of the actuation arm 268 may place the position switch 260 in a closed arrangement (e.g., capable of conducting current).

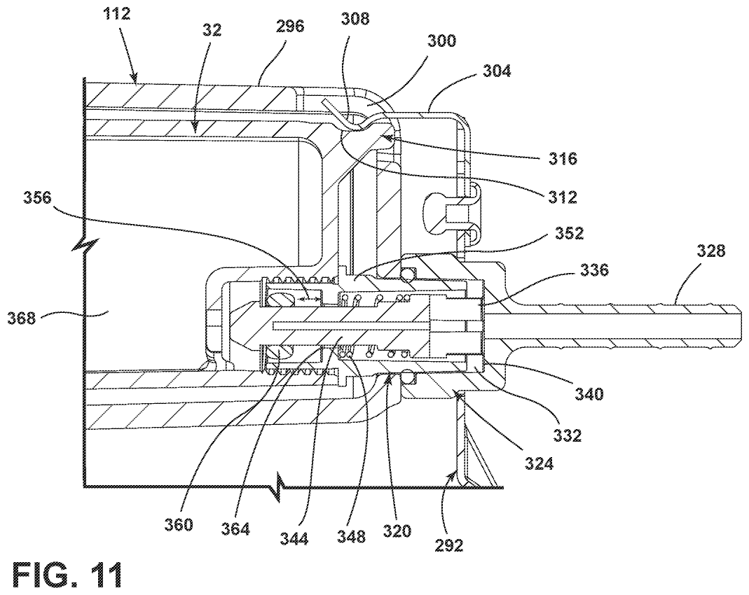

Referring now to FIGS. 10 and 11, a mounting bracket 292 may be provided proximate to a rear of the fluid tank 32 and/or a rear of the tank housing 112. The mounting bracket 292 can aid in maintaining proper positioning of the tank housing 112 and/or the fluid tank 32. In the depicted example, an upper surface 296 of the tank housing 112 defines a bracket aperture 300. The bracket aperture 300 may receive a retention arm 304 of the mounting bracket 292. A contour 308 of the retention arm 304 can engage with a retention recess 312 of a retention rib 316 of the fluid tank 32. Engagement between the retention arm 304 and the retention rib 316 can provide a resistance to extraction of the fluid tank 32 from the tank housing 112 and maintain contact between a fluid valve 320 of the fluid tank 32 and a valve receptacle 324 of the cooking appliance 20. Engagement between the retention arm 304 and the retention rib 316 may also provide a tactical feedback signal to user that the fluid tank 32 has been fully installed. The valve receptacle 324 includes a tubular projection 328 extending therefrom. The tubular projection 328 may be employed in fluid coupling between the fluid tank 32 and the vapor generator 44. For example, one or more sections of conduit or tubing may extend from the tubular projection 328 to the vapor generator 44.

Referring now to FIG. 11, when the fluid tank 32 is fully-inserted into the tank housing 112, the fluid valve 320 is received within a recess 332 of the valve receptacle 324. A valve actuator 336 extends from a rear wall 340 of the recess 332. The valve actuator 336 engages with a plunger 344 of the fluid valve 320. The engagement between the valve actuator 336 and the plunger 344 causes compression of a valve spring 348 and movement of the plunger 344 within a valve housing 352. As the plunger 344 is displaced by the valve actuator 336, a distance 356 between a valve seal 360 and a valve seal seat 364 increases. By increasing the distance 356 between the valve seal 360 and the valve seal seat 364, fluid communication is established between an interior 368 of the fluid tank 32 and the tubular projection 328.

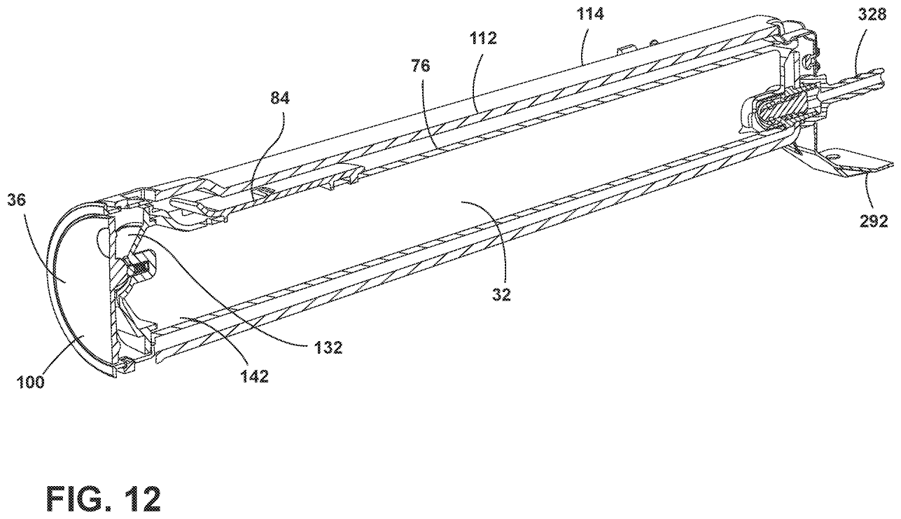

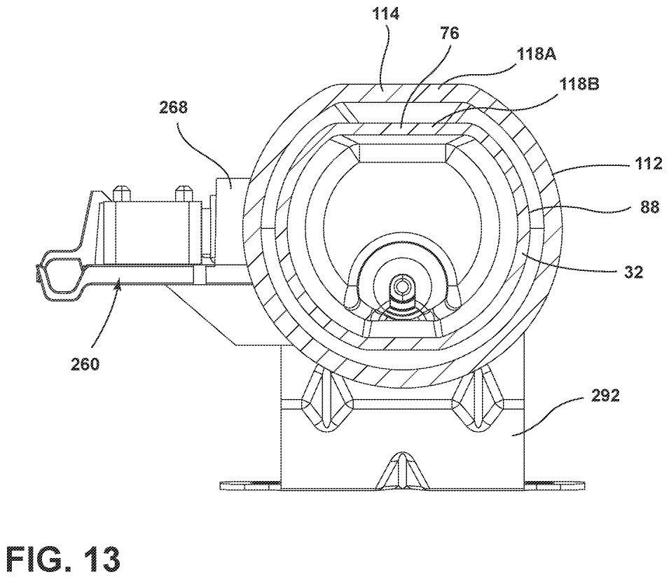

As shown in FIG. 12, the fluid tank 32 may be received within the tank housing 112. The tank housing 112, in turn, may be mounted to the body 24, such that the handle may be flush or substantially coplanar with the front surface 108 of the body 24 when the fluid tank 32 is the installed position. As perhaps best seen in FIG. 13, the fluid tank 32 includes the upper surface 76 and the tank housing 112 includes an upper surface 114. Each of the upper surface 76 of the fluid tank 32 and the upper face 114 of the tank housing 112 may be formed as parallel horizontal chords on a circular outer periphery of fluid tank 32 and the tank housing 112, respectively. So arranged, each of the upper surface 76 of the fluid tank 32 and the upper face 114 of the tank housing 112 form a set of cooperating alignment surfaces 118A, 118B that that may allow insertion of the fluid tank 32 within the tank housing 112 in a single angular orientation relative the front surface 108 of the body 24 only, such that the upper surface 76 and the fill aperture 80 on the fluid tank 32 may be always oriented on the uppermost surface of the fluid tank 32 when in the installed position.

To facilitate removal of the fluid tank 32 when in the installed position to maintain the fill aperture 80 on the fluid tank 32 oriented on the uppermost surface of the fluid tank 32, the axis 40 about which the handle 36 is configured to rotate may be a horizontal axis, as noted above. Accordingly, the axis 40 may be in a horizontal orientation when in the fluid tank 32 is within the tank housing in the single angular orientation, wherein the handle 36 may be rotatable about the horizontal axis 40 while the fluid tank 32 is withdrawn from the installed position to the extended position, and visa versa.

According to another aspect of the present disclosure, a cooking appliance includes a body and a cooking cavity defined by the body. A fluid tank may be removably coupled to the body, wherein the fluid tank is movable between an installed position and an extended position relative to the body, and wherein the fluid tank comprises a handle that is rotatable about an axis between a neutral position and a rotated position. A vapor generator may be in fluid communication with and receives a fluid from the fluid tank, wherein vapor produced by the vapor generator is provided to the cooking cavity.

According to another aspect of the present disclosure, the handle of the fluid tank may include an exterior surface and an interior surface, and the exterior surface of the handle may be substantially coplanar with a front surface of the body when the fluid tank is in the installed position and the handle is in the neutral position.

According to yet another aspect of the present disclosure, the fluid tank may include a handle-supporting portion having an upper portion angled away from interior surface of the handle such that the interior surface of the handle at an upper region of the handle is spaced from the upper portion when the handle is in the neutral position and contacts an adjacent surface of the upper portion of the handle-supporting portion in the rotated position.

According to a further aspect of the present disclosure, an angled orientation of the upper portion of the handle-supporting portion extends from an area proximate to the axis to a perimeter wall of the handle-supporting portion.

According to yet another aspect of the present disclosure, the handle-supporting portion has a lower portion angled away from the interior surface of the handle such that the interior surface of the handle at a lower region of the handle is spaced from the lower portion when the handle is in the neutral position.

According to a further aspect of the present disclosure, the upper portion and the lower portion of the handle-supporting portion are asymmetrical with one another along at least one cross-sectional plane of the fluid tank.

According to still another aspect of the present disclosure, the interior surface of the handle is provided with an upper protrusion positioned in an upper region thereof, such that the upper protrusion contacts the adjacent surface of the handle-supporting portion in the rotated position.

According to another aspect of the present disclosure, the interior surface of the handle is provided with a lower protrusion positioned in a lower region thereof, such that the lower protrusion contacts an adjacent surface of the lower portion of the handle-supporting portion in the rotated position.

According to another aspect of the present disclosure, a cooking appliance includes a body, a cooking cavity defined by the body, and a fluid tank removably coupled to the body. The fluid tank may be movable between an installed position and an extended position relative to the body, and the fluid tank comprises a handle that is rotatable about an axis between a neutral position and a rotated position and a handle-supporting portion having an angled portion angled away from an interior surface of the handle such that the interior surface of the handle at a predetermined region of the handle is spaced from the angled portion when the handle is in the neutral position and contacts an adjacent surface of the angled portion of the handle-supporting portion when the handle is in the rotated position. A vapor generator may be in fluid communication with and that receives a fluid from the fluid tank, wherein vapor produced by the vapor generator is provided to the cooking cavity.

According to a further aspect of the present disclosure, an engagement member may be disposed on the handle-supporting portion, and a biasing member biases the engagement member to an extended position such that the engagement member maintains physical contact with the handle.

According to another aspect of the present disclosure, the interior surface of the handle includes a projection extending from the interior surface and toward the engagement member, and wherein a cavity within the handle-supporting portion includes a channel that receives the biasing member and the engagement member.

According to yet another aspect of the present disclosure, the projection of the handle defines a notch within which the engagement member is received.

According to still another aspect of the present disclosure, a pair of notches are defined on the projection and the pair of notches are separated by a step, and a first one of the pair of notches is associated with the neutral position of the handle and a second one of the pair of notches is associated with the rotated position of the handle, whereby when the handle is in the neutral position, the biasing member provides a biasing force in an outward direction from the channel such that the engagement member is held in physical contact with the first one of the pair of notches and when the handle is in the rotated position, the biasing member provides a force in an outward direction from the channel such that the engagement member is in physical contact with the second one of the pair of notches.

According to an additional aspect of the present disclosure, when an inward force is applied to the predetermined region of the handle while the handle is in the neutral position, the handle is transitioned toward the rotated position and the engagement member is transitioned from the first one to the second one of the pair of notches, such that the handle is retained in the rotated position until a second external force is applied to the handle.

According to another aspect of the present disclosure, the axis is disposed parallel to a horizontal plane, and the predetermined region of the handle is defined as a region above the axis relative the horizontal plane.

According to an additional aspect of the present disclosure, the handle of the fluid tank includes pivot brackets that extend from the interior surface, each pivot bracket defining a slot therein, and wherein each of the slots receive a tab that extends from the handle-supporting portion of the fluid tank.

According to yet another aspect of the present disclosure, the fluid tank is received within a tank housing mounted to the body and collectively the fluid tank and the tank housing comprise a set of cooperating alignment surfaces that allow insertion of the fluid tank within the tank housing in a single angular orientation relative a front surface of the body, such that a fill aperture on the fluid tank is oriented on an upper surface of the fluid tank when in the installed position.

According to a further aspect of the present disclosure, a cooking appliance includes a cooking cavity defined by a body, and a fluid tank removably coupled to the body, wherein the fluid tank is movable between an installed position and an extended position relative to the body, and wherein the fluid tank comprises a handle that is rotatable about an axis rotatable between a neutral position and a rotated position, and wherein the fluid tank comprises an upper handle-adjacent surface and a lower handle-adjacent surface each sloped away from the handle such that an upper recess and a lower recess are provided. A vapor generator may be in fluid communication with and that receives a fluid from the fluid tank, wherein vapor produced by the vapor generator is provided to the cooking cavity.

According to an additional aspect of the present disclosure, an interior surface of the handle at an upper region of the handle is spaced from the upper handle-supporting adjacent surface when the handle is in the neutral position and the upper region of the handle contacts the upper handle-supporting adjacent surface in the rotated position.

According to still another aspect of the present disclosure, the fluid tank further includes a fill aperture disposed on an upper surface of the fluid tank through which the fluid may be added to the fluid tank when the fluid tank is in the extended position. An opening may be proximate the fill aperture. A fill cover may be constructed of a pliable material and configured to retain the fluid within the fluid tank, wherein a snap tab on a first end of the fill cover may be fittingly received within the opening to secure the fill cover to the upper surface of the of the fluid tank proximate the fill aperture, a rib may be provided on an inner surface of the fill cover resiliently engages an outer perimeter of the fill aperture to form a seal therewith when engaged, and a grip on a second opposite end of the fill cover may be provided by which a user may manipulate the fill cover into and out of engagement with the fill aperture.

According to a further aspect of the present disclosure, a cooking appliance includes a body, a cooking cavity defined by the body, a fluid tank, and a vapor generator. The fluid tank is removably coupled to the body. The fluid tank is movable between an installed position and an extended position relative to the body. The fluid tank includes a handle that is rotatable about an axis. The vapor generator receives fluid from the fluid tank. Vapor produced by the vapor generator is provided to the cooking cavity.

According to another aspect of the present disclosure, a handle of a fluid tank includes an exterior surface and an interior surface. The exterior surface of the handle is substantially coplanar with a front surface of a body of a cooking appliance when the fluid tank is in an installed position.

According to another aspect of the present disclosure, an interior surface of a handle is provided with an upper protrusion positioned in an upper region thereof.

According to another aspect of the present disclosure, an interior surface of a handle is provided with a lower protrusion positioned in a lower region thereof.

According to another aspect of the present disclosure, a fluid tank includes an engagement member and a biasing member. The biasing member biases the engagement member to an extended position such that the engagement member maintains physical contact with a portion of a handle.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooking appliance, comprising:
a body;
a cooking cavity defined by the body;
a fluid tank removably coupled to the body, wherein the fluid tank is movable between an installed position and an extended position relative to the body, and wherein the fluid tank comprises a handle that is rotatable about an axis between a neutral position and a rotated position; and
a vapor generator in fluid communication with and that receives a fluid from the fluid tank, wherein vapor produced by the vapor generator is provided to the cooking cavity.

2. The cooking appliance of claim 1, wherein the handle of the fluid tank comprises an exterior surface and an interior surface, and wherein the exterior surface of the handle is substantially coplanar with a front surface of the body when the fluid tank is in the installed position and the handle is in the neutral position.

3. The cooking appliance of claim 2, wherein the fluid tank comprises a handle-supporting portion having an upper portion angled away from interior surface of the handle such that the interior surface of the handle at an upper region of the handle is spaced from the upper portion when the handle is in the neutral position and contacts an adjacent surface of the upper portion of the handle-supporting portion in the rotated position.

4. The cooking appliance of claim 3, wherein an angled orientation of the upper portion of the handle-supporting portion extends from an area proximate to the axis to a perimeter wall of the handle-supporting portion.

5. The cooking appliance of claim 4, wherein the handle-supporting portion has a lower portion angled away from the interior surface of the handle such that the interior surface of the handle at a lower region of the handle is spaced from the lower portion when the handle is in the neutral position.

6. The cooking appliance of claim 5, wherein the upper portion and the lower portion of the handle-supporting portion are asymmetrical with one another along at least one cross-sectional plane of the fluid tank.

7. The cooking appliance of claim 3, wherein the interior surface of the handle is provided with an upper protrusion positioned in an upper region thereof, such that the upper protrusion is in contact with the adjacent surface of the handle-supporting portion in the rotated position.

8. The cooking appliance of claim 5, wherein the interior surface of the handle is provided with a lower protrusion positioned in a lower region thereof, such that the lower protrusion is in contact with an adjacent surface of the lower portion of the handle-supporting portion in the rotated position.

9. A cooking appliance, comprising:
a body;
a cooking cavity defined by the body;
a fluid tank removably coupled to the body, wherein the fluid tank is movable between an installed position and an extended position relative to the body, and wherein the fluid tank comprises a handle that is rotatable about an axis between a neutral position and a rotated position and a handle-supporting portion having an angled portion angled away from an interior surface of the handle such that the interior surface of the handle at a predetermined region of the handle is spaced from the angled portion when the handle is in the neutral position and contacts an adjacent surface of the angled portion of the handle-supporting portion when the handle is in the rotated position; and
a vapor generator in fluid communication with and that receives a fluid from the fluid tank, wherein vapor produced by the vapor generator is provided to the cooking cavity.

10. The cooking appliance of claim 9, further comprising:
an engagement member disposed on the handle-supporting portion; and
a biasing member, wherein the biasing member biases the engagement member to an extended position such that the engagement member maintains physical contact with the handle.

11. The cooking appliance of claim 10, wherein the interior surface of the handle includes a projection extending from the interior surface and toward the engagement member, and wherein a cavity within the handle-supporting portion includes a channel that receives the biasing member and the engagement member.

12. The cooking appliance of claim 11, wherein the projection of the handle defines a notch within which the engagement member is received.

13. The cooking appliance of claim 12, wherein a pair of notches are defined on the projection and the pair of notches are separated by a step, and wherein a first one of the pair of notches is associated with the neutral position of the handle and a second one of the pair of notches is associated with the rotated position of the handle, whereby when the handle is in the neutral position, the biasing member provides a biasing force in an outward direction from the channel such that the engagement member is held in physical contact with the first one of the pair of notches and when the handle is in the rotated position, the biasing member provides a force in an outward direction from the channel such that the engagement member is in physical contact with the second one of the pair of notches.

14. The cooking appliance of claim 13, wherein when an inward force is applied to the predetermined region of the handle while the handle is in the neutral position, the handle is transitioned toward the rotated position and the engagement member is transitioned from the first one to the second one of the pair of notches, such that the handle is retained in the rotated position until a second external force is applied to the handle.

15. The cooking appliance of claim 14, wherein the axis is disposed parallel to a horizontal plane, and the predetermined region of the handle is defined as a region above the axis relative the horizontal plane.

16. The cooking appliance of claim 9, wherein the handle of the fluid tank includes pivot brackets that extend from the interior surface, each pivot bracket defining a slot therein, and wherein each of the slots receive a tab that extends from the handle-supporting portion of the fluid tank.

17. The cooking appliance of claim 9, wherein the fluid tank is received within a tank housing mounted to the body and collectively the fluid tank and the tank housing comprise a set of cooperating alignment surfaces that allow insertion of the fluid tank within the tank housing in a single angular orientation relative a front surface of the body, such that a fill aperture on the fluid tank is oriented on an upper surface of the fluid tank when in the installed position.

18. A cooking appliance, comprising:
a cooking cavity defined by a body;
a fluid tank removably coupled to the body, wherein the fluid tank is movable between an installed position and an extended position relative to the body, and wherein the fluid tank comprises a handle that is rotatable about an axis rotatable between a neutral position and a rotated position, and wherein the fluid tank comprises an upper handle-adjacent surface and a lower handle-adjacent surface each sloped away from the handle such that an upper recess and a lower recess are provided; and
a vapor generator in fluid communication with and that receives a fluid from the fluid tank, wherein vapor produced by the vapor generator is provided to the cooking cavity.

19. The cooking appliance of claim 18, wherein an interior surface of the handle at an upper region of the handle is spaced from the upper handle-supporting adjacent surface when the handle is in the neutral position and the upper region of the handle is in contact with the upper handle-supporting adjacent surface in the rotated position.

20. The cooking appliance of claim 19, wherein the fluid tank further comprises:
a fill aperture disposed on an upper surface of the fluid tank through which the fluid may be added to the fluid tank when the fluid tank is in the extended position;
an opening proximate the fill aperture; and
a fill cover constructed of a pliable material and configured to retain the fluid within the fluid tank, wherein a snap tab on a first end of the fill cover is fittingly received within the opening to secure the fill cover to the upper surface of the of the fluid tank proximate the fill aperture, a rib provided on an inner surface of the fill cover resiliently engages an outer perimeter of the fill aperture to form a seal therewith when engaged, and a grip on a second opposite end of the fill cover is provided by which a user may manipulate the fill cover into and out of engagement with the fill aperture.
